(19) United States
(12) Patent Application Publication
(10) Pub. No.: US 2008/0000985 A1
(43) Pub. Date: Jan. 3, 2008

(54) FINANCIAL TRANSACTION CARD WITH MIRROR-LIKE REFLECTIVE SURFACE

(75) Inventor: Rima Randa Bdeir, Beirut (LB)

Correspondence Address: BAKER & DANIELS LLP, 300 NORTH MERIDIAN STREET, SUITE 2700, INDIANAPOLIS, IN, 46204, US

(73) Assignee: BANK AUDI SAL - AUDI SARADAR GROUP, Beirut (LB)

(21) Appl. No.: 11/673,254

(22) Filed: Feb. 9, 2007

Related U.S. Application Data
(60) Provisional application No. 60/806,510, filed on Jul. 3, 2006.

(51) Int. Cl. G06K 19/02; G06K 19/06

(52) U.S. Cl. 235/488; 235/491; 235/492; 235/493

(57) ABSTRACT

The present invention involves a financial transaction card having a mirror-like surface and method of making the same. The card has a clear, mirror-like reflective surface on at least a portion of the front surface of the card, yet still operates like other financial transaction cards. The advantage of the mirror-like reflective surface is that the card provides the additional function of the mirror and imparts a heightened level of status to the card user as compared to users of ordinary cards.

### BACKGROUND OF THE INVENTION

1. Field of the Invention

The invention relates generally to financial transaction cards, including credit cards, debit cards and automatic teller machine (ATM) cards.

2. Description of the Related Art

Credit cards, as we know them today, have been around for just over half of a century. In 1950, the Diners Club produced the first “general purpose” charge card, which is similar to the modern charge card but required that the entire bill be paid with each statement. People soon grasped the “charge it” concept and began using the Diners Club Card. The concept caught on and by 1952 the Card was accepted at thousands of merchants.

An automatic teller machine (ATM) allows a bank customer to conduct his/her banking transactions from almost every other ATM machine in the world. The machine is an electronic computerized telecommunications device that allows a bank's customers, using an ATM card, to directly use a secure method of communication to access their bank accounts, order or make cash withdrawals and check their account balances without the need for a human bank teller. The first true bank ATMs became functional in 1971.

Debit cards look like credit cards or ATM (automated teller machine) cards, but operate like cash or a personal check. Debit cards thus are different from credit cards in their operation. While a credit card is a way to “pay later,” a debit card is a way to “pay now.” When people use debit cards, their money is quickly deducted from their checking or savings account. Debit cards increasingly became common in the 1990s as an alternative to credit cards, and have been promoted as safer than cash and more convenient than personal checks. Large credit-card companies typically issue debit cards through their participating banks. Thus, for example, Mastercard® may issue a debit card through several different banks with whom it has a relationship.

Financial transaction cards (e.g., credit cards, debit cards, or ATM cards) commonly have a magnetic stripe on the back of the card. The magnetic stripe, also called a magstripe, is capable of storing data by modifying the magnetism of tiny iron-based magnetic particles on a band of magnetic material on the card. The magnetic stripe is read when it makes physical contact with and by swiping past a reading head. When the card is swiped through a reader, the software at the point of sale (POS) terminal (which contains the reader) dials a stored telephone number to call an acquirer. An acquirer is an organization that collects credit authentication requests from merchants and provides a payment guarantee to the merchant. When the acquirer company gets the credit card authentication request, it checks the transaction for validity, and checks the recorded information stored on the magstripe for: Merchant ID, Valid card number, Expiration date, Credit card limit, and Card usage. Generally, if the information is valid, and the card has not yet expired and is not yet over its limit, the account on the card is charged for the purchase and the purchase is permitted.

### SUMMARY OF THE INVENTION

The present invention relates to a financial transaction card having a mirror-like reflective surface, yet still operates like other conventional financial transaction cards. The advantage of the present invention is that the mirror-like reflective surface provides the additional function of a mirror and adds a level of panache or perceived higher status to the mirrored card user, as compared to users of ordinary cards. The plastic financial transaction card includes a mirror-like surface covering a portion of the top surface of the card. Credit card logos corresponding to the issuing card company may be pre-printed on the right side of the card. Other indicia of origin may also be pre-printed on the front of the card, even on the mirror-like reflective surface. The card itself is generally rectangular, and may have the mirror like surface covering over 50% of its front surface.

The present invention, in another form, relates to the process involved in creating the card. The financial transaction card with the mirror-like surface is obtained as the result of a hot stamping process. Hot Stamping, also known as Foil Stamping, is a letterpress or relief printing process that uses a combination of metal printing plates with raised images, hot stamping foil, heat, pressure and time. Typically, the heat, pressure and time factors are delivered by a hot stamping machine. This printing process delivers the bright, metallic finishes that characterize the mirror-like reflective surface. A wide variety of substrates can be hot stamped. A substrate is any surface or material on which printing is done.

Along with the convenience of using the card, the cardholder will have the added feature of the mirror-like reflective surface. For the end-user, the credit card may replace a hand-held mirror saving space in a purse, wallet, or pocket. Furthermore, competition to gain the business of more consumers is fierce among credit card companies. Therefore, credit card companies are always looking to gain an advantage over their competitors. Efforts are constantly made to provide cards with attractive, distinctive appearances to lure consumers to choose one particular card over others.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a planar view of a first embodiment of a financial transaction card produced in accordance with the present invention.

FIG. 2 is a block diagram flow chart illustrating the sequence of steps in the method of the invention for making the financial transaction card of FIG. 1.

FIG. 3 is a view of a second embodiment of a financial transaction card and its use according to the present invention.

FIG. 4 is a planar view of a second embodiment of a financial transaction card produced in accordance with the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below are not intended to be exhaustive or limit the invention to the precise form disclosed in the following detailed description. Rather, the embodiments are chosen and described so that others skilled in the art may utilize its teachings. It is noted here that although the specification refers repeatedly to a “credit card,” the invention is also equally applicable to credit cards, debit cards, ATM cards, chip cards, smart cards and the like. These will be referred to collectively as “financial transaction cards.”

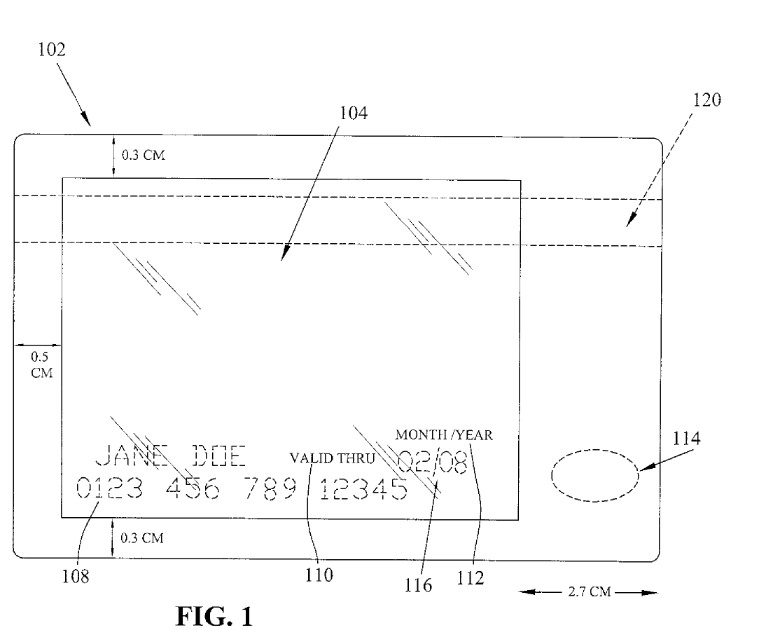

Referring now to the drawings, FIG. 1 illustrates credit card 102 according to one embodiment of the present invention, which has a generally rectangular exterior perimeter sized as a standard credit card. FIG. 1 shows the front side of credit card 102 according to an exemplary embodiment of the invention, the front surface of card 102 having hot stamped, mirror-like reflective area 104. Reflective area 104, in this exemplary embodiment, has a border of 0.3 cm from the top and bottom edge of card 102 and 0.5 cm border from the left side of card 102. Reflective area 104 includes customer identification area 108 which may include a name and/or an account or other identifying number. The words ‘valid thru’ 110 and ‘month/year’ 112 may be pre-printed on card 102 for later use with expiration date 116, which may change based on when the card expires. Other indicia 114, which can include credit card company logos, may be placed on the right portion of card 102. Indicia 114 may include indicia of origin and/or other card or issuer identifying information.

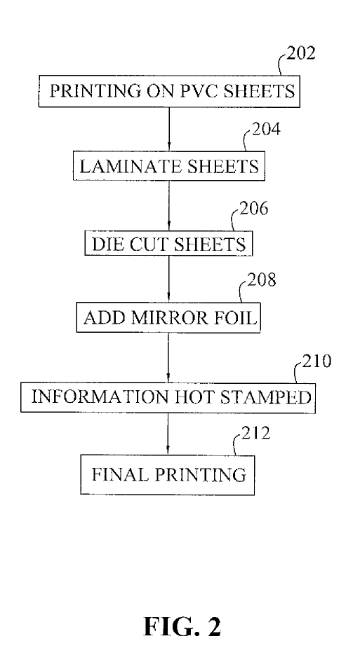

FIG. 2 is a block diagram flow chart illustrating the sequence of steps in the method of the invention for making the credit card of FIG. 1. PVC sheets are printed (step 202) and laminated (step 204), which may include affixing with the credit card brand logo. The sheets are then separated, for example by being die cut (step 206), to form individual printed cards. Also, a hot stamping process adds the mirror foil (step 208) to the top of the card. Another credit card logo may be hot stamped (step 210) and final printing (step 212) may then be done over the foil. The hot stamping process may be done prior to or after the separation into individual cards.

The hot stamping process passes in many stages during manufacturing until reaching the clean mirror-like reflective surface appearance. In the first stage of an exemplary process, Polyvinyl Chloride (PVC) sheets may be printed with the credit card company's brand logo and laminated. Printing may be done using ultraviolet curable ink. Ultraviolet curable ink composition that enables the printing of high-resolution images on a variety of substrates (especially Plastics). The composition of ultraviolet curable ink may include an ultraviolet curable adhesive in combination with a selected dye pigment and one or more solvents. Such a composition is typically applied using a thermal ink jet delivery system. After application, the composition may be exposed to ultra-violent light, resulting in the formation of a permanent image. The materials and methods of the invention are capable of producing a high-resolution image on the mirror foil without causing damage to the substrates.

The sheets of printed PVC may then be die cut and separated to become printed cards. The cards may then be sent through a hot stamping process to add the mirror foil on top of the cards. A border may be provided on three sides of the card between the edge of the card and the edge of the foil. Any other images, logos, or indicia of card origin may be hot stamped onto the card and final printing is done over the foil.

Some textual markings on the card may be pre-printed during this process, including the words ‘Valid Thru’ and “Month/Year,” along with various logos and other marketing or identifying images. Once the card is issued to a cardholder, identifying information such as the cardholder's name may be printed onto the top surface of the card along with the cardholder's name, address and/or account number. Optionally, names, addresses, account numbers, etc., may be physically embossed from the back of the card resulting in raised letter print on the face of the card. Magnetic stripe 120 on the rear of card 102 may also be encoded to store information such as card issuer information, cardholder name, and account number and expiration date. Other methods of information storage, such as electronic information storage (as a chip card or other electronic circuit), radio frequency identification, or optical information storage, may be used to store identifying information.

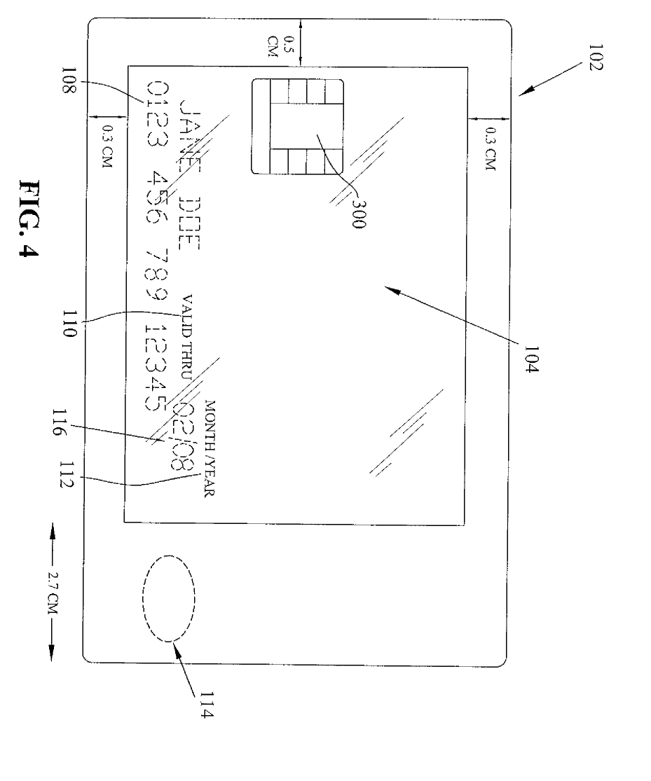

Once the card is issued, the cardholder may use the card as he/she would use any other conventional card for financial transactions. For example, in transacting business over the Internet, the cardholder may select the name of the credit card company from a list of companies and enter his/her credit card number and expiration date when making an online purchase. When completing a financial transaction at a physical (i.e., non-Internet) location of a business, information from the card may be read from the magnetic strip using automated card processing equipment, or from an electronic chip card (see FIG. 4) or other memory device card.

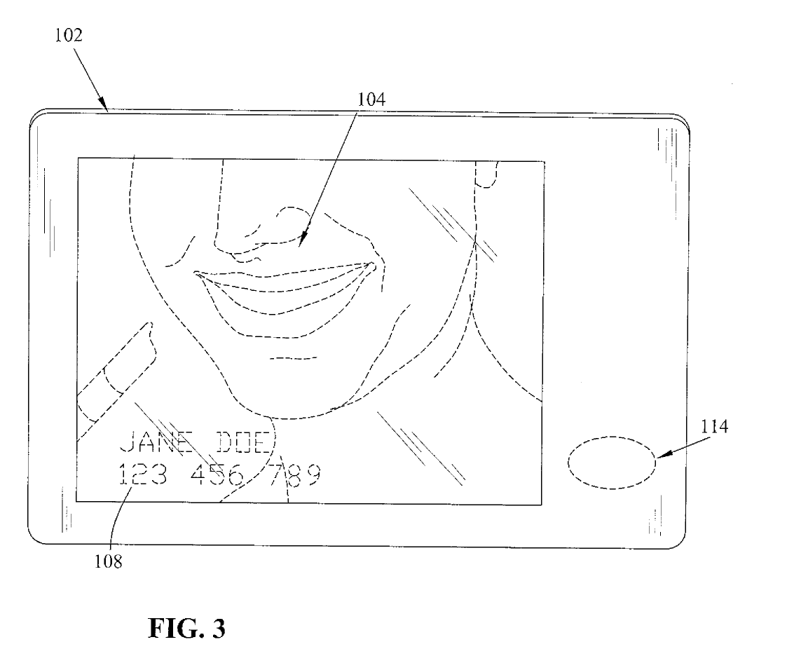

FIG. 3 shows an embodiment of the present invention, wherein a substantial portion (e.g., over 50%) of the front surface of the card has the mirror-like reflective surface. As shown, the credit card user may use the card as a mirror, e.g., to examine lipstick or hair arrangement, in place of a separate hand mirror. The reflective surface of the financial transaction card is sufficiently precise for the individual to discern the details on her/his face.

FIG. 4 shows a second embodiment of the present invention which is similar to the embodiment of FIG. 1, but without a magnetic stripe instead having chip 300 located within the body of the card. Chip 300 provides an electronic storage capability for the card, which may be in the form of an integrated circuit, a radio frequency identification chip, or other information storage device.

The present invention also includes a method for financial transaction card companies to promote themselves and increase their market share by offering to the public a financial transaction card having a mirror-like surface. Often, individuals carry a small mirror in addition to several other items in a purse or wallet. With a financial transaction card having a mirror-like surface, the individual may satisfy the desire for a small mirror and save space by using the financial transaction card that may also function as a small mirror. Financial transaction card companies can advertise or promote a financial transaction card having a mirror-like surface to members of the public to entice them to obtain a financial transaction card from the financial transaction card company. By providing a financial transaction card that may function as a hand mirror, many individuals may opt for such a financial transaction card and thus the issuer of such a financial transaction card would increase its market share.

While this invention has been described as having an exemplary embodiment, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A financial transaction card comprising: a plastic substrate in the form of a generally rectangular card; an laminated layer; and a mirror-like foil overlayed on at least a portion of a first surface of said laminate layer.

2. The card according to claim 1, further comprising textual material printed with ultraviolet curable ink on a portion of said plastic substrate.

3. The card according to claim 1, further comprising identifying information means located on said card.

4. The card according to claim 3, wherein said identifying information means includes a magnetic stripe which is attached to said card on a second surface of said plastic substrate opposite said first surface of said card.

5. The card according to claim 3, wherein said identifying information means includes a chip.

6. The card according to claim 5, wherein said chip is attached to a first surface of said card.

7. A method of making a card with a mirror-like reflective foil comprising the steps of providing a plastic substrate, applying a laminated layer, and applying a mirror-like foil on at least a portion of a first surface of said laminated layer.

8. The method according claim 7, further comprising the step of printing ink graphics with ultraviolet curable ink on said first surface.

9. The method according claim 7, further comprising the step of printing identifying information means on said card.

10. The method according claim 9, wherein said identifying information means includes a magnetic stripe which is attached to said card on a second surface of said plastic substrate opposite said first surface of said first surface.

11. The method according to claim 7, wherein said plastic substrate is in the form of a large sheet containing a plurality of cards, individual cards being die cut to card size from said sheet after applying said laminated layer.

12. An article of manufacture prepared by a process comprising the steps of: providing a plastic substrate, applying a laminated layer, and applying a mirror-like foil on at least a portion of a first surface of said laminated layer.

13. The article of manufacture of claim 12, wherein the process further comprises the step of printing ink graphics with ultraviolet curable ink on said first surface.

14. The article of manufacture of claim 12, wherein the process further comprises the step of printing identifying information means on said card.

15. The article of manufacture of claim 14, wherein said identifying information means includes a magnetic stripe which is attached to said card on a second surface of said plastic substrate opposite said first surface of said first surface.

16. A plastic card comprising a mirror-like foil covering a portion of the card, wherein said mirror-like foil covering provides a mirror-like reflective surface on said card.

17. The plastic card according to claim 16, further comprising indicia of origin pre-printed on said first surface of card.

18. A method for utilizing in a financial transaction a financial transaction card having a mirror-like reflective foil on at least a portion of a first surface of said card, the method comprising:
obtaining a financial transaction card having a mirror-like reflective foil; and
using said financial transaction card in a financial transaction.

19. The method according to claim 18, wherein said card further comprises indicia pre-printed on said first surface of card.

20. A method of attracting customers for an issuer of a financial transaction card, comprising offering to the public a financial transaction card having a mirror-like reflective foil on at least a portion of a first surface of said card.
